(19) United States
(12) Patent Application Publication
(10) Pub. No.: US 2015/0271089 A1
(43) Pub. Date: Sep. 24, 2015

(54) SELECTIVE HIGH-PRIORITY BANDWIDTH ALLOCATION FOR TIME-DIVISION MULTIPLE ACCESS COMMUNICATIONS

(71) Applicants: Lin TANG, (US); Patrick K.M TSE, (US); QUALCOMM INCORPORATED, San Diego, CA (US)

(72) Inventors: Lin Tang, Shanghai (CN); Patrick K.M. Tse, Toronto (CA)

(21) Appl. No.: 14/430,190

(22) PCT Filed: Oct. 29, 2012
(86) PCT No.: PCT/CN2012/083690

§ 371 Date: Mar. 20, 2015

(51) Int. Cl. H04L 12/873; H04L 12/835

(52) U.S. Cl. CPC H04L 47/522; H04L 47/30

(57) ABSTRACT

To allocate bandwidth in a system that includes a master device coupled to a plurality of slave devices, the status of a low-priority queue and a high-priority queue in a slave device of the plurality of slave devices is monitored. The low-priority queue stores low-priority upstream traffic and the high-priority queue stores high-priority upstream traffic. A length of time for which the high-priority queue is empty is measured and a determination is made as to whether the length of time satisfies a threshold. When the high-priority queue is empty and the length of time does not satisfy the threshold, bandwidth is reserved for the high-priority queue. When the high-priority queue is empty and the length of time satisfies the threshold, no bandwidth is reserved for the high-priority queue.

### TECHNICAL FIELD

The present embodiments relate generally to communication systems, and specifically to networks that use time-division multiple access (TDMA) and have multiple-priority network traffic.

### BACKGROUND OF RELATED ART

A system in which a master device is coupled to multiple slave devices may be implemented using a Time-Division Multiple Access (TDMA) protocol, such that access to the medium coupling the devices is time-multiplexed among the devices. For example, the master device receives reports from respective slave devices that specify how much traffic is queued for transmission in the respective slave devices. The master device then allocates bandwidth among the slave devices based in part on the reports. The delay between the reports and the availability of the subsequently allocated bandwidth introduces latency, which is undesirable for high-priority traffic.

### BRIEF DESCRIPTION OF THE DRAWINGS

The present embodiments are illustrated by way of example and are not intended to be limited by the figures of the accompanying drawings.

FIG. 1 is a block diagram of a system with coax links in accordance with some embodiments.

FIG. 2A illustrates a sequence of beacon periods in accordance with some embodiments.

FIG. 2B illustrates time slots in a beacon period in accordance with some embodiments.

FIGS. 3A and 3B are block diagrams of a master device coupled to a plurality of slave devices in accordance with some embodiments.

FIG. 4A is a flowchart illustrating a method of operating a scheduler in a master device that monitors the status of high-priority queues in slave devices in accordance with some embodiments.

FIG. 4B is a flowchart illustrating a method of operating a report module that monitors the status of a high-priority queue and of operating a corresponding zero-traffic counter in a slave device in accordance with some embodiments.

FIG. 5 is a flowchart illustrating a method of selectively reserving bandwidth for an empty high-priority queue in accordance with some embodiments.

FIG. 6A is a block diagram of a master device in accordance with some embodiments.

FIG. 6B is a block diagram of a slave device in accordance with some embodiments.

Like reference numerals refer to corresponding parts throughout the drawings and specification.

### DETAILED DESCRIPTION

Embodiments are disclosed in which bandwidth is selectively allocated to an empty high-priority queue in a networked device, based at least in part on a length of time that the high-priority queue has been empty.

In some embodiments, a method of allocating bandwidth is performed in a system that includes a master device coupled to a plurality of slave devices. In the method, the status of a low-priority queue and a high-priority queue in a slave device of the plurality of slave devices is monitored. The low-priority queue stores low-priority upstream traffic and the high-priority queue stores high-priority upstream traffic. A length of time for which the high-priority queue is empty is measured and a determination is made as to whether the length of time satisfies a threshold. When the high-priority queue is empty and the length of time does not satisfy the threshold, bandwidth is reserved for the high-priority queue. When the high-priority queue is empty and the length of time satisfies the threshold, no bandwidth is reserved for the high-priority queue.

In some embodiments, a master device is to be coupled to a plurality of slave devices in a system. The master device includes a physical-layer device (PHY) to transmit signals to and receive signals from the plurality of slave devices. The received signals including reports from a respective slave device reporting the status of a low-priority queue and a high-priority queue in the respective slave device. The master device also includes a scheduler to allocate bandwidth for the high-priority queue when the high-priority queue is reported to be empty for a length of time that does not satisfy a threshold and to allocate no bandwidth for the high-priority queue when the high-priority queue is reported to be empty for a length of time that satisfies the threshold.

In some embodiments, a slave device is to be coupled to a master device in a system. The slave device includes a low-priority queue to store low-priority upstream traffic and a high-priority queue to store high-priority upstream traffic. The slave device also includes a report module to generate reports on the status of the low-priority queue and the high-priority queue for transmission to the master device. Respective reports indicate that the high-priority queue is empty when the high-priority queue has been empty for a length of time that satisfies a threshold and indicate that the high-priority queue has a non-zero queue size and thus is not empty when the high-priority queue has been empty for a length of time that does not satisfy the threshold.

In the following description, numerous specific details are set forth such as examples of specific components, circuits, and processes to provide a thorough understanding of the present disclosure. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The term “coupled” as used herein means connected directly to or connected through one or more intervening components or circuits. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scope all embodiments defined by the appended claims.

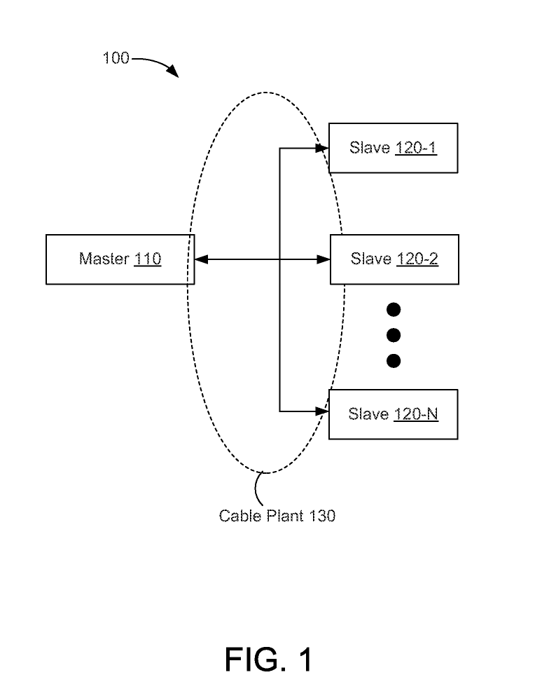

FIG. 1 illustrates a system (e.g., an access network) 100 in which a master device 110 is coupled to multiple slave devices 120-1 through 120-N, where N is an integer greater than one, in accordance with some embodiments. In some embodiments, the master device 110 is coupled to the slave devices 120-1 through 120-N using coaxial cable (“coax”) links that compose a cable plant 130. For example, the system 100 may be an Ethernet over Coax (EoC) access network. In some embodiments, the system 100 may be implemented in accordance with the HomePlug AV/IEEE1901 standard(e.g., as adapted for use with a coax medium).Transmissions from the master device 110 to the slave devices 120-1 through 120-N are referred to as downstream traffic and transmissions from respective slave devices 120-1 through 120-N to the master device 110 are referred to as upstream traffic.

Access to the medium (e.g., the coax links of the cable plant 130) that couples that devices 110 and 120-1 through 120-N is time-multiplexed using a Time-Division Multiple Access (TDMA) protocol. In some embodiments, the master device 110 periodically broadcasts a medium access schedule (also referred to as a channel access schedule) to all slave devices 120-1 through 120-N. For example, the channel access schedule is periodically broadcast in a message called a beacon message or simply a beacon. The channel access schedule assigns dedicated time slots to respective slave devices 120, such that a respective slave device 120 may transmit during its dedicated time slot and not during time slots assigned to other slave devices 120. A scheduler in the master device 110 determines the amount of medium access for each slave device 120, based for example on the service level agreements (SLAs) between end users associated with respective slave devices 120 and the service provider(e.g., cable operator) who controls the master device 110. The scheduler constructs the channel access schedule based on the determined amounts of medium access for the slave devices 120.

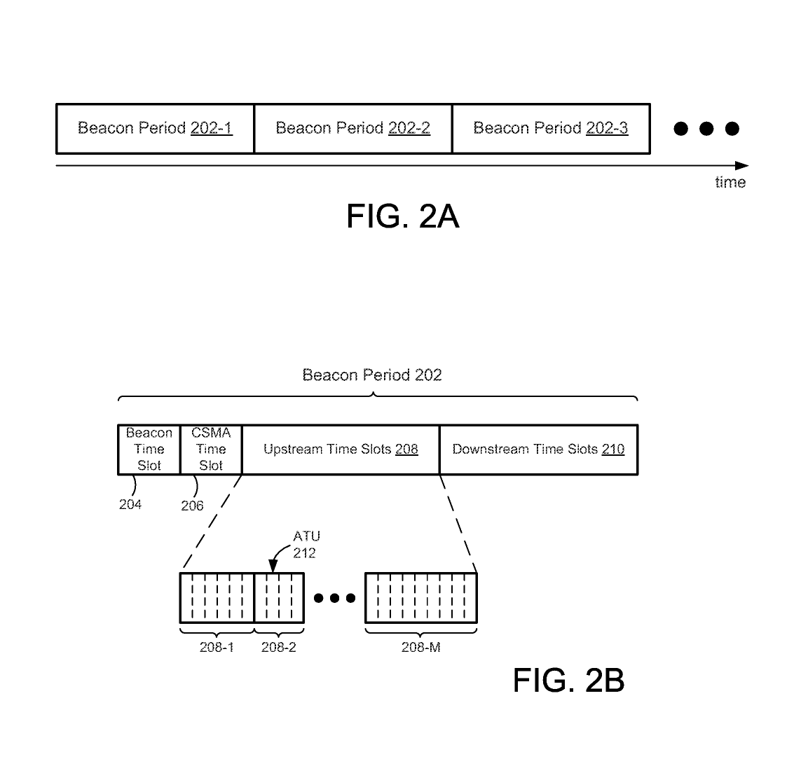

The period between broadcasts of successive channel access schedules (e.g., the period from the beginning of a beacon message to the beginning of the next beacon message) is called a beacon period. FIG. 2A illustrates a sequence of beacon periods in accordance with some embodiments: a first beacon period 202-1 is followed by a second beacon period 202-2, which is followed in turn by a third beacon period 202-3. Each beacon period 202 is divided into different time slots, as shown in FIG. 2B in accordance with some embodiments. A first time slot 204 is allocated for transmission of the beacon message and thus for transmission of the channel access schedule. A second time slot 206 is a contention-based time slot in which the slave devices 120-1 through 120-N may compete for transmission bandwidth in accordance with a carrier-sense multiple access (CSMA) protocol. For example, newly activated slave devices 120 may compete to use the contention-based time slot 206 to register with the master device 110. In some embodiments, the contention-based time slot 206 is not included in every beacon period 202, but instead is only included in a portion of the beacon periods 202.

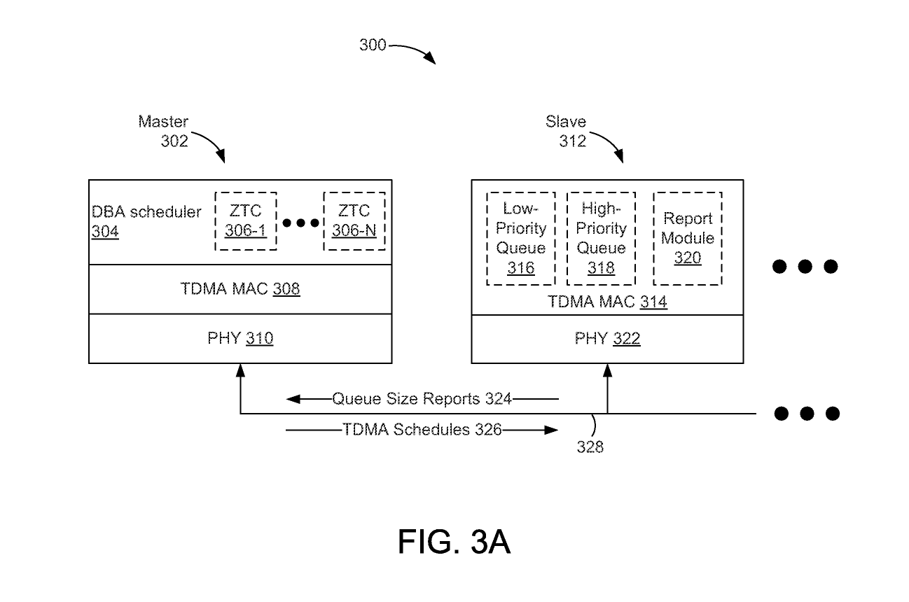

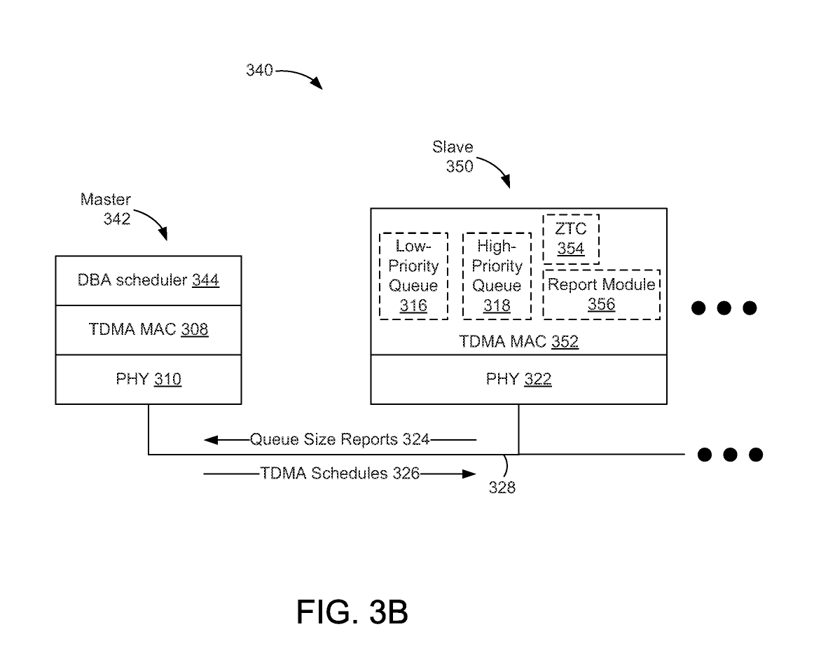

Each beacon period 202 further includes upstream time slots 208 and downstream time slots 210. The time slots 208 and 210 are allocated in accordance with a time-division multiple access (TDMA) protocol. Respective upstream time slots 208 are assigned to respective slave devices 120 for upstream transmissions to the master device 110. These assignments are based at least in part on the reported status of transmission queues in the slave devices 120. For example, a slave device 120 may have multiple queues (e.g., low-priority queue 316 and high-priority queue 318, FIGS. 3A-3B), each of which buffers upstream traffic of a given priority (e.g., low priority or high priority). When an upstream time slot 208 is assigned to a specific slave device 120, traffic buffered in one or more queues of that slave device 120 may be transmitted upstream to the master device 110 during the time slot 208. A first upstream time slot 208-1 thus may be assigned to a first slave device 120-1, a second upstream time slot 208-2 may be assigned to a second slave device 120-2, and so on. In some embodiments, each slave device 120 determines how to allocate time in an assigned time slot 208 among its queues. Alternatively, the master device 110 may assign respective time slots 208 to specific queues. A total of M upstream time slots 208 are assigned to M slave devices 120 (or alternatively, M queues), where M is the number of slave devices 120 (or alternatively, queues) allowed to transmit during a respective beacon period 202. The number M may vary from beacon period 202 to beacon period 202, depending for example on the available bandwidth and demand for bandwidth during different beacon periods 202.

Downstream time slots 210 are allocated for downstream transmissions by the master device 110. The downstream time slots 210 may include time slots for unicast transmissions to specific slave devices 120 as well as a time slot for broadcasts to all of the slave devices 120-1 through 120-N. Because the downstream time slots 210 are allocated to the master device 110, the slave devices 120 do not transmit during the downstream time slots 210.

In some embodiments, the lengths (i.e., durations) of the time slots 204, 206, 208, and/or 210 are variable, as shown for the time slots 208-1, 208-2, and 208-M in FIG. 2B. For example, the scheduler in the master device 110 assigns time slots of different lengths to different slave devices 120, in accordance with a dynamic bandwidth allocation (DBA) algorithm. The time slots 204, 206, 208, and 210 are divided into fixed-length allocation time units (ATUs) 212, such that each time slot is an integer number of ATUs 212. An ATU 212 is thus the unit of time for specifying the length of a time slot. In some embodiments (e.g., in accordance with the HomePlug AV/IEEE 1901 standard), an ATU 212 is 10.24 us. The beacon message specifies the length of each time slot by specifying the number of ATUs 212 assigned to each time slot. For example, respective fields in the beacon message contain bits specifying the number of ATUs 212 for respective time slots. The bits specifying the number of ATUs 212 for a respective time slot may be spread over more than one field in the beacon message (e.g., may be divided between two fields). Also, a respective field may include a first set of bits for a first time slot and a second set of bits for a second time slot.

In each beacon period 202 (e.g., during respective upstream time slots 208), the slave devices 120-1 through 120-N report their amounts of queued upstream traffic to the master device 110 so that the master device 110 can create an appropriate channel access schedule for a subsequent (e.g., the next) beacon period 202. The amount of queued upstream traffic for a respective slave device 120 may include the amount of low-priority traffic queued for upstream transmission in the slave device 120 and the amount of high-priority traffic queued for upstream transmission in the slave device 120. The channel access schedule for the subsequent (e.g., next) beacon period 202 assigns upstream time slots 208 based on the reported amounts of queued upstream traffic. As such, the channel access schedule reflects requested upstream bandwidth from the previous beacon period 202, resulting in a minimum latency of one beacon period. (The channel access schedule may also reflect the levels of service provided for in the service level agreements.)

For high-priority traffic (e.g., voice-over-Internet-Protocol (VoIP) traffic) that is sensitive to latency and jitter, this one-beacon-period latency is particularly detrimental. To mitigate this problem, bandwidth (e.g., the smallest available unit of bandwidth) may be reserved for empty high-priority queues in slave devices 120: the channel access schedule may include bandwidth for high-priority queues in the allocation that determines the upstream time slots 208 assigned to the slave devices 120, even if the queues are reported as being empty. If a high-priority packet then arrives in a queue before an assigned time slot 208, the packet is transmitted during the assigned time slot 208 and does not have to wait for a subsequent beacon period 202. Reserving bandwidth for high-priority queues thus reduces latency for high-priority traffic. However, reserving even the smallest unit of bandwidth for unforeseen high-priority traffic may cause significant performance degradation in some implementations if the reserved bandwidth goes unused. For example, in the HomePlug AV/IEEE 1901 standard the smallest unit of bandwidth is an OFDM symbol plus its overhead, which is approximately 160 us in duration. Reservation of such a large amount of bandwidth for traffic that may not arrive is wasteful.

Accordingly, a minimum amount of bandwidth is reserved for high-priority upstream traffic from a slave device 120 even if the slave device has no pending high-priority upstream traffic, but only if the slave device 120 has not had any high-priority upstream traffic for a length of time (e.g., a number of beacon periods 202) that does not satisfy (e.g., is less than, or less than or equal to) a specified threshold. If the length of time (e.g., the number of beacon periods 202) for which the slave device 120 has not had any high-priority upstream traffic satisfies (e.g., is greater than or equal to, or greater than) the specified threshold, then no bandwidth for high-priority upstream traffic is reserved. The intelligence for implementing this selective bandwidth allocation may reside in the master device 110 or the slave device 120.

FIG. 3A illustrates a system 300 in which this intelligence is implemented in a master device 302 in accordance with some embodiments. The master device 302 is coupled to slave devices 312 by a coax link 328. The system 300 is an example of the system 100 (FIG. 1). The master device 302 includes a physical layer device (PHY) 310 (e.g., a HomePlug AV PHY) to transmit and receive signals (e.g., OFDM signals) over the coax link 328, a TDMA media access controller (MAC) 308 coupled to the PHY 310, and a dynamic bandwidth allocation (DBA) scheduler 304 coupled to the TDMA MAC 308. The slave device 312 includes a PHY 322 (e.g., a HomePlug AV PHY) to transmit and receive signals (e.g., OFDM signals) over the coax link 328 and a TDMA MAC 314 coupled to the PHY 322.

The TDMA MAC 314 of the slave device 312 includes a low-priority queue 316 to store low-priority traffic (e.g., low-priority packets) for subsequent upstream transmission to the master device 302 and a high-priority queue 318 to store high-priority traffic (e.g., high-priority packets) for subsequent upstream transmission to the master device 302. The terms low-priority and high-priority as used herein are used with respect to each other: low-priority traffic has lower priority than high-priority traffic, and vice versa. The TDMA MAC 314 also includes a report module 320 that monitors the status (e.g., the length, and thus the amount queued traffic) of the queues 316 and 318 and prepares reports 324 for transmission to the master device 302 that report the status of the queues 316 and 318. The slave device 312 transmits these reports 324 to the master device 302 during upstream time slots 208 (FIG. 2B).

The DBA scheduler 304 of the master device 302, which generates TDMA schedules 326 for transmission to slave devices 312 (e.g., during time slots 204, FIG. 2B), includes a plurality of zero-traffic counters (ZTCs) 306-1 through 306-N, each corresponding to a respective slave device 312. Each counter 306 counts a number of successive beacon periods 202 (FIGS. 2A-2B)in which the high-priority queue 318 of the corresponding slave device 312 is reported to be empty. When a slave device 312 reports that its high-priority queue 318 is not empty, the corresponding zero-traffic counter 306 is reset (e.g., cleared to zero).

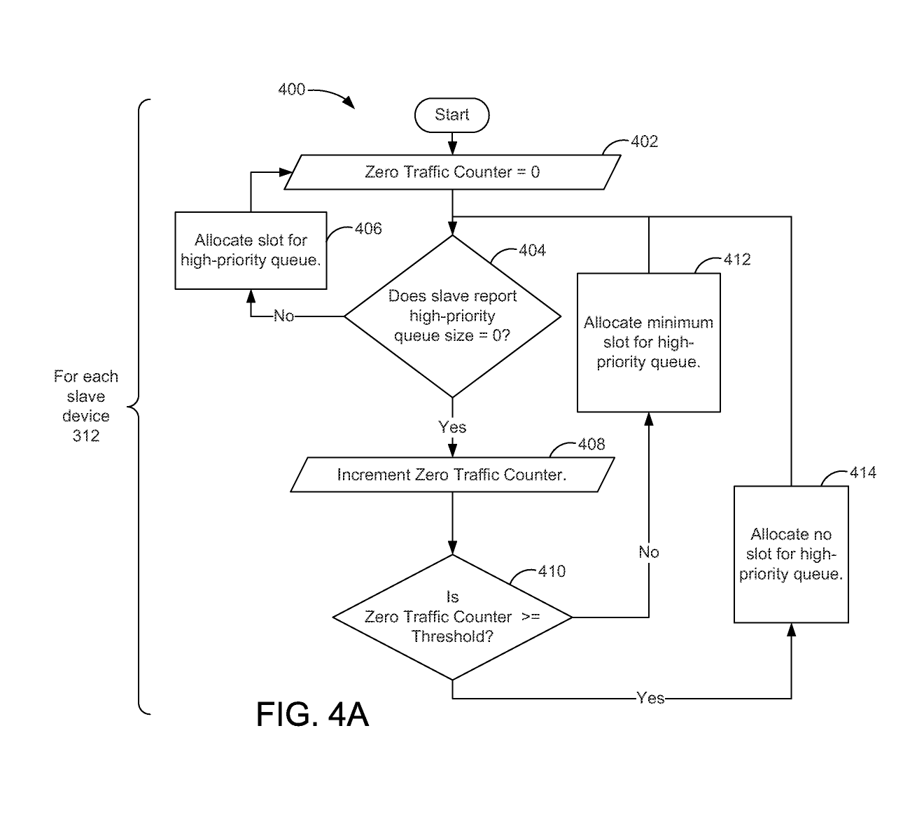

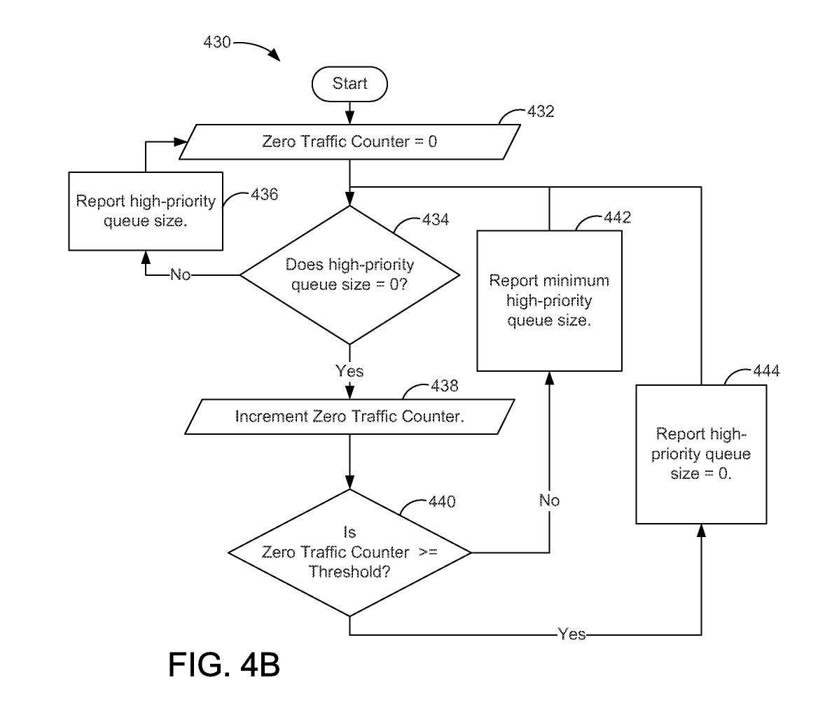

The operation of the DBA scheduler 304 with respect to the zero-traffic counters 306-1 through 306-N is illustrated in FIG. 4A in accordance with some embodiments. The method 400 of FIG. 4A is performed separately for each slave device 312 (or a portion of the slave devices 312) coupled to the master device 302. In the method 400, a zero-traffic counter 306 is initially set to zero (402). If the slave device 312 corresponding to the zero-traffic counter 306 reports that its high-priority queue 318 is not empty and thus has a non-zero queue size (404-No), then the scheduler 304 allocates (406) an upstream time slot 208 (FIG. 2B) for the high-priority queue 318 or includes time for the high-priority queue 318 in an upstream time slot 208 assigned to the slave device 312.

If, however, the slave device 312 reports that its high-priority queue 318 is empty and thus has a queue size of zero (404-Yes), then the scheduler 304 increments (408) the zero-traffic counter 306 by one count. A determination is then made (410) as to whether the value of the zero-traffic counter 306 satisfies (e.g., is greater than or equal to, or alternatively is greater than) a threshold. If the value does not satisfy the threshold (410-No), then the scheduler 304 allocates (412) an upstream time slot 208 (FIG. 2B) of a predefined duration (e.g., a duration corresponding to a single OFDM symbol) for the high-priority queue 318 or includes time for the high-priority queue 318 in an upstream time slot 208 assigned to the slave device 312). If, however, the value satisfies the threshold (410-Yes), then the scheduler 304 does not allocate (414) an upstream time slot 208 (FIG. 2B) to the high-priority queue 318. The method 400 then returns to operation 404, in which the scheduler 304 analyzes a slave report for the next beacon period 202, and the method 400 repeats.

The method 400 thus allows a predefined amount of bandwidth to be allocated for high-priority traffic for a slave device 312 even though the slave device 312 reports no pending high-priority traffic. In the case of bursty high-priority (e.g., VoIP) traffic, the slave device 312 will immediately (e.g., during its next available upstream transmission slot 208) use this bandwidth to transmit the high-priority traffic, thus minimizing latency. If the slave device 312 reports no pending high-priority traffic for a number of consecutive periods, the minimum amount of bandwidth will cease to be allocated for high-priority traffic, to avoid wasting bandwidth indefinitely. Furthermore, implementing the intelligence for this selective bandwidth allocation in the master device 302 allows this selective bandwidth allocation to be implemented without any changes to the slave devices 312, such that the method 400 is compatible with legacy slave devices 312. Also, implementing the intelligence in the master device 302 puts the system operator (e.g., the cable operator) in control of the selective allocation.

FIG. 3B illustrates a system 340 in which the intelligence for selective high-priority bandwidth allocation is implemented in a slave device 350 in accordance with some embodiments. The slave device 350 is one of a number of slave devices coupled to a master device 342 by a coax link 328. The system 340 is an example of the system 100 (FIG. 1). The master device 342 includes a PHY 310 (e.g., a HomePlug AV PHY), a TDMA MAC 308 coupled to the PHY 310, and a DBA scheduler 344 coupled to the TDMA MAC 308. The DBA scheduler 344 generates TDMA schedules 326 for transmission to slave devices 312 (e.g., during time slots 204, FIG. 2B). The slave device 350 includes a PHY 322 (e.g., a HomePlug AV PHY) and a TDMA MAC 352 coupled to the PHY 322.

The TDMA MAC 352 includes a low-priority queue 316 and a high-priority queue 318, as described with respect to FIG. 3A. The TDMA MAC 352 also includes a zero-traffic counter 354 that counts a number of successive beacon periods 202 (FIGS. 2A-2B) in which the high-priority queue 318 is empty, and a report module 356 that reports the status of the queues 316 and 318 to the master device 342 in reports 324.

Operation of the report module 356 and zero-traffic counter 354 is illustrated in FIG. 4B in accordance with some embodiments. In the method 430 of FIG. 4B, the zero-traffic counter 354 is initially set to zero (432). The report module 356 monitors the status of the high-priority queue 318. If the high-priority queue 318 has high-priority traffic in it and thus is not empty (434-No), then the report module 356 reports (436) the size of the high-priority queue 318 to the master device 342.

If, however, the high-priority queue 318 is empty (434-Yes), then the zero-traffic counter 354 is incremented (438) by one count. A determination is then made (440) as to whether the value of the zero-traffic counter 354 satisfies (e.g., is greater than or equal to, or alternatively is greater than) a threshold. If the value does not satisfy the threshold (440-No), then the report module 356 reports (442) to the master device 342 that the high-priority queue 318 has a non-zero queue size (e.g., a minimum queue size, corresponding for example to a single packet), despite the fact that the high-priority queue 318 is actually empty. If the value satisfies the threshold (440-Yes), then the report module 356 reports (444) to the master device 342 that the high-priority queue 318 is empty. The reported size of the high-priority queue 318 is thus a function of both the actual queue size and the value of the zero-traffic counter 354. The method 430 then returns to the operation 434 and repeats for successive beacon periods.

By reporting a non-zero queue size when the high-priority queue 318 is empty, the slave device 350 reserves bandwidth for bursty high-priority traffic. By only reporting this non-zero queue size when the zero-traffic counter 354 does not satisfy the threshold, the slave device 350 avoids wasting bandwidth indefinitely. Furthermore, implementing the intelligence for this selective bandwidth allocation in the slave device 350 allows the slave device 350 to selectively reserve bandwidth for only certain types of high-priority traffic, thus reducing unnecessary bandwidth reservation. For example, the zero-traffic counter 354 may operate for only to a particular type of queued high-priority traffic, such as VoIP traffic (e.g., the counter increments when no VoIP traffic is queued and is cleared when a VoIP packet is queued for transmission).

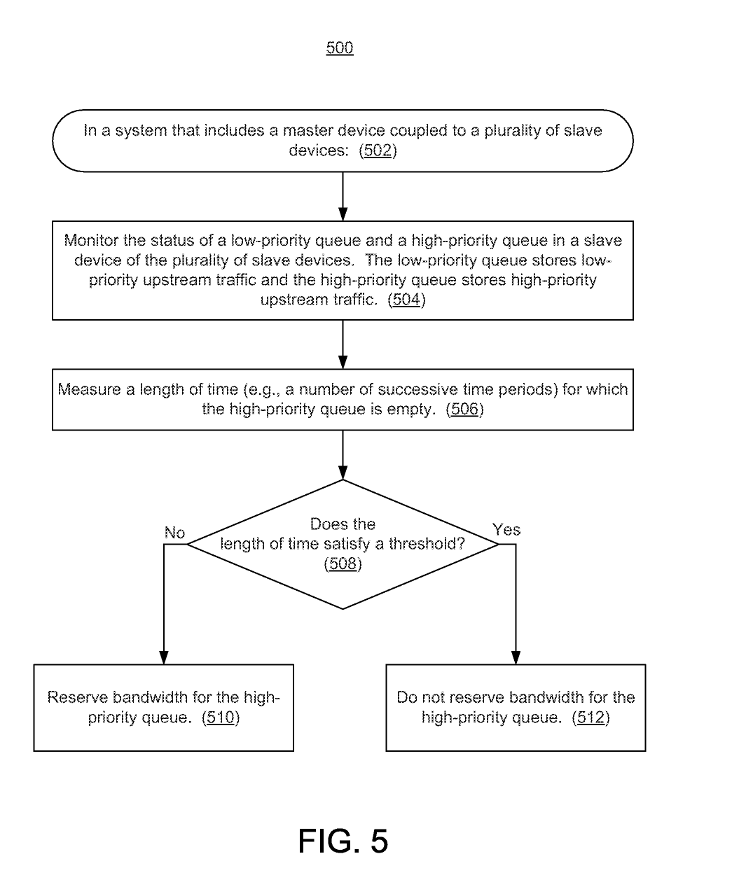

Attention is now directed to a general method 500 of selectively reserving bandwidth for an empty high-priority queue 318, as illustrated in FIG. 5 in accordance with some embodiments. The method 500 is performed (502) in a network (e.g., the system 100, FIG. 1) that includes a master device (e.g., master device 110, FIG. 1) coupled to a plurality of slave devices (e.g., slave devices 120-1 through 120-N, FIG. 1). In some embodiments, the method 500 is performed by a master device 302 (FIG. 3A) and corresponds to the method 400 (FIG. 4A). In some other embodiments, the method 500 is performed by a slave device 350 (FIG. 3B) and corresponds to the method 430 (FIG. 4B).

The status of a low-priority queue (e.g., queue 316, FIGS. 3A-3B) and a high-priority queue (e.g., queue 318, FIGS. 3A-3B) in a slave device of the plurality of slave devices is monitored (504). The low-priority queue stores low-priority upstream traffic and the high-priority queue stores high-priority upstream traffic (e.g., VoIP traffic). In one example, the master device 302 (FIG. 3A) performs this monitoring by receiving reports from the slave device 312 reporting amounts of traffic in the low-priority queue 316 and the high-priority queue 318. In another example, the report module 356 in the slave device 350 (FIG. 3B) performs this monitoring.

A length of time is measured (506) for which the high-priority queue is empty. For example, a number of successive time periods (e.g., successive beacon periods 202, FIGS. 2A-2B) in which the high-priority queue is empty is counted.

A determination is made (508) as to whether the length of time satisfies (e.g., is greater than, or greater than or equal to) a threshold. In some embodiments, the threshold is a threshold number of time periods (e.g., beacon periods 202, FIGS. 2A-2B), and making the determination 508 includes comparing the number of successive time periods in which the high-priority queue is empty to the threshold number.

If the length of time does not satisfy the threshold (508-No), bandwidth (e.g., a predefined and/or minimum available amount of bandwidth) is reserved (510) for the high-priority queue.

For example, the master device 302 (FIG. 3A) transmits a message that includes a bandwidth allocation for the high-priority queue 318. The message may be a beacon message that allocates upstream time slots 208 (FIG. 2B) among the plurality of slave devices and assigns to the slave device 312 an upstream time slot 208 that includes the bandwidth allocation for the high-priority queue 318.

In another example, the slave device 350 (FIG. 3B) transmits a report to the master device 342 reporting a non-zero queue size for the high-priority queue 318, despite the high-priority queue 318 being empty, and receives an allocation of bandwidth that includes bandwidth corresponding to the reported non-zero queue size from the master device 342 in response. The allocation of bandwidth may be received in a beacon message that allocates upstream time slots 208 among the plurality of slave devices and assigns to the slave device 350 an upstream time slot 208 that includes bandwidth for the high-priority queue 318.

If the length of time satisfies the threshold (508-Yes), no bandwidth is reserved (512) for the high-priority queue.

For example, the master device 302 (FIG. 3A) transmits a message that does not allocate bandwidth to the high-priority queue 318. The message may be a beacon message that allocates upstream time slots 208 (FIG. 2B) among the plurality of slave devices and does not allocate an upstream time slot 208 for the high-priority queue 318.

In another example, the slave device 350 (FIG. 3B) transmits a report to the master device 342 reporting a zero queue size for the high-priority queue 318 and in response receives an allocation of no bandwidth for the high-priority queue 318 from the master device 342. The allocation of no bandwidth may be specified in a beacon message that allocates upstream time slots 208 among the plurality of slave devices.

In some embodiments, the threshold is configurable and may be adjusted by the system operator. For example, the system operator may adjust the threshold to achieve a target latency (e.g., a target average latency) for high-priority upstream traffic. Increasing the threshold reduces average latency for high-priority traffic, at the cost of reducing through-put for low-priority traffic. Reducing the threshold increases average latency for high-priority traffic, but improves through-put for low-priority traffic. Reducing the threshold to zero effectively deactivates bandwidth reservation for empty high-priority queues 318.

In some embodiments, the method 500 further includes implementing a limit on bandwidth allocated for high-priority traffic in a slave device when both the low-priority and high-priority queues are not empty. For example, when the low-priority queue is not empty (or has a length greater than, or greater than or equal to, a specified value), the DBA scheduler 304 (FIG. 3A) or 344 (FIG. 3B) determines an allocation of bandwidth for the high-priority queue and then compares this allocation to a predefined limit. If the allocation is greater than the predefined limit, the allocation is reduced to the predefined limit. The allocation is thus the minimum of the determined allocation and the predefined limit. Remaining bandwidth, if any, may then be allocated to the low-priority queue to prevent low-priority traffic starvation. If, however, the low-priority queue is empty (or has a length less than, or less than or equal to, the specified value), then the predefined limit is not invoked. Also, the DBA scheduler 304 or 344 may be configurable such that the system operator may disable the predefined limit.

While the method 500 includes a number of operations that appear to occur in a specific order, it should be apparent that the method 500 can include more or fewer operations, which can be executed serially or in parallel. An order of two or more operations may be changed and two or more operations may be combined into a single operation. For example, all of the operations of the method 500 may be performed in an ongoing basis for successive beacon periods 202 (FIGS. 2A-2B).

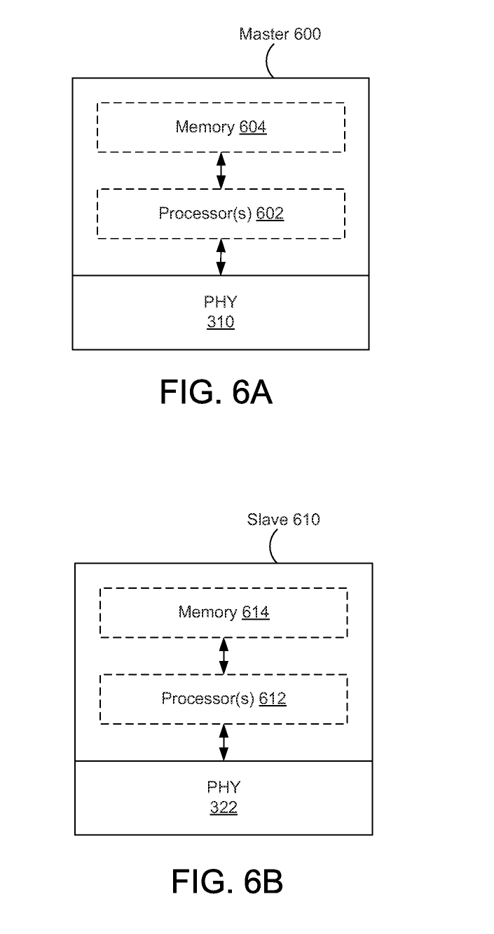

In some embodiments, the TDMA MAC 308 and/or scheduler 304 (FIG. 3A) or 344 (FIG. 3B) in a master device 302 (FIG. 3A) or 342 (FIG. 3B) are implemented in software. FIG. 6A is a block diagram of a master device 600 that is an example of such a master device 302 or 342 in accordance with some embodiments. In the master device 600, the PHY 310 (FIGS. 3A-3B) is coupled to one or more processor cores 602, which are coupled to memory 604. In some embodiments, the memory 604 includes a non-transitory computer-readable medium (e.g., one or more nonvolatile memory elements, such as EPROM, EEPROM, Flash memory, a hard disk drive, and so on) that stores instructions for execution by the one or more processor cores 602. In the example of the master device 302 (FIG. 3A), the instructions include instructions that, when executed by the processor core(s) 602, cause the master device 600 to perform all or a portion of the methods 400 (FIG. 4A) and/or 500 (FIG. 5).

In some embodiments, the TDMA MAC 314 (FIG. 3A) and/or 352 (FIG. 3B) in a slave device 312 (FIG. 3A) or 350 (FIG. 3B) is implemented in software. FIG. 6B is a block diagram of a slave device 610 that is an example of such a slave device 312 (FIG. 3A) or 350 (FIG. 3B) in accordance with some embodiments. In the slave device 610, the PHY 322 (FIGS. 3A-3B) is coupled to one or more processor cores 612, which are coupled to memory 614. In some embodiments, the memory 614 includes a non-transitory computer-readable medium (e.g., one or more nonvolatile memory elements, such as EPROM, EEPROM, Flash memory, a hard disk drive, and so on) that stores instructions for execution by the one or more processor cores 612. In the example of the slave device 350 (FIG. 3B), the instructions include instructions that, when executed by the processor core(s) 612, cause the slave device 610 to perform all or a portion of the methods 430 (FIG. 4B) and/or 500 (FIG. 5).

While the memories 604 (FIG. 6A) and 614 (FIG. 6B) are shown as being separate from respective processor core(s) 602 and 612, all or a portion of the memories 604 and/or 614 may be embedded in the respective processor cores 602 and 612(s). In some embodiments, the processor core(s) 602 and/or 612 are implemented in the same integrated circuit as respective PHYs 310 and 322. For example, the PHYs 310 and/or 322 may be integrated with the respective processor cores(s) 602 and 612 in single chips, which may or may not also include the respective memories 604 and 614.

In the foregoing specification, the present embodiments have been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A method of allocating bandwidth in a system comprising a master device coupled to a plurality of slave devices, the method comprising:
monitoring the status of a low-priority queue and a high-priority queue in a slave device of the plurality of slave devices, wherein the low-priority queue stores low-priority upstream traffic and the high-priority queue stores high-priority upstream traffic;
measuring a length of time for which the high-priority queue is empty;
determining whether the length of time satisfies a threshold;
when the high-priority queue is empty and the length of time does not satisfy the threshold, reserving bandwidth for the high-priority queue; and
when the high-priority queue is empty and the length of time satisfies the threshold, reserving no bandwidth for the high-priority queue.

2. The method of claim 1, wherein:
measuring the length of time comprises counting a number of successive time periods in which the high-priority queue is empty;
the threshold is a threshold number of time periods; and
determining whether the length of time satisfies the threshold comprises comparing the number of successive time periods to the threshold number of time periods.

3. The method of claim 1, wherein:
the method is performed by the master device;
reserving bandwidth for the high-priority queue comprises transmitting a first message containing a bandwidth allocation for the high-priority queue; and
reserving no bandwidth for the high-priority queue comprises transmitting a second message containing no bandwidth allocation for the high-priority queue.

4. The method of claim 3, wherein monitoring the status of the low-priority queue and the high-priority queue in the slave device comprises receiving reports from the slave device reporting amounts of traffic in the low-priority queue and the high-priority queue.

5. The method of claim 4, wherein:
the length of time comprises a number of successive beacon periods;
a respective report is received from the slave device in a first beacon period; and
the first message is transmitted in response to the respective report in a second beacon period subsequent to the first beacon period.

6. The method of claim 3, wherein:
transmitting the first message comprises broadcasting a message to the plurality of slave devices allocating time slots among the plurality of slave devices; and
the first message assigns a time slot to the slave device that includes the bandwidth allocation for the high-priority queue.

7. The method of claim 3, wherein:
transmitting the second message comprises broadcasting a message to the plurality of slave devices allocating time slots among the plurality of slave devices.

8. The method of claim 1, wherein:
the method is performed by the slave device; and
reserving bandwidth for the high-priority queue comprises:
transmitting a first report to the master device reporting a non-zero queue size for the high-priority queue, despite the high-priority queue being empty; and
in response to the first report, receiving from the master device an allocation of bandwidth that includes bandwidth corresponding to the non-zero queue size for the high-priority queue.

9. The method of claim 8, wherein:
receiving the allocation comprises receiving from the master device a message broadcast to the plurality of slave devices allocating time slots among the plurality of slave devices; and
the message assigns a time slot to the slave device that includes bandwidth corresponding to the non-zero queue size.

10. The method of claim 8, wherein:
the length of time comprises a number of successive beacon periods;
the first report is transmitted to the master device in a first beacon period; and
the allocation of bandwidth is for a second beacon period subsequent to the first beacon period.

11. The method of claim 8, wherein reserving no bandwidth comprises transmitting a second report to the master device reporting a zero queue size for the high-priority queue.

12. The method of claim 1, wherein the high-priority upstream traffic stored in the high-priority queue comprises Voice over Internet Protocol (VoIP) traffic.

13. The method of claim 1, further comprising adjusting the threshold in accordance with a target latency for the high-priority upstream traffic.

14. The method of claim 1, wherein reserving bandwidth for the high-priority queue comprises reserving a predefined amount of bandwidth for the high-priority queue.

15. The method of claim 1, further comprising:
when the high-priority queue and the low-priority queue are not empty, limiting bandwidth allocated for the high-priority queue to a predefined amount.

16. A master device to be coupled to a plurality of slave devices in a system, the master device comprising:
a physical-layer device (PHY) to transmit signals to and receive signals from the plurality of slave devices, the received signals including reports from a respective slave device reporting the status of a low-priority queue and a high-priority queue in the respective slave device; and
a scheduler to allocate bandwidth for the high-priority queue when the high-priority queue is reported to be empty for a length of time that does not satisfy a threshold and to allocate no bandwidth for the high-priority queue when the high-priority queue is reported to be empty for a length of time that satisfies the threshold.

17. The master device of claim 16, wherein:
the reports comprise respective reports indicating whether the high-priority queue is empty during successive time periods;
the scheduler comprises a counter to count a number of successive time periods in which the high-priority queue is reported to be empty; and
the threshold is a threshold number of time periods.

18. The master device of claim 17, wherein:
the successive time periods comprise successive beacon periods;
the scheduler is to prepare a channel access schedule for a respective beacon period, wherein the channel access schedule assigns to the respective slave device a time slot including a predefined amount of bandwidth allocated for the high-priority queue when the number of successive time periods does not satisfy the threshold and assigns no time to the respective slave device allocated for the high-priority queue when the number of successive time periods satisfies the queue.

19. The master device of claim 18, further comprising a media access controller (MAC), coupled to the PHY and the scheduler, to prepare a broadcast message containing the channel access schedule for transmission to the plurality of slave devices.

20. A slave device to be coupled to a master device in a system, the slave device comprising:
a low-priority queue to store low-priority upstream traffic;
a high-priority queue to store high-priority upstream traffic; and
a report module to generate reports on the status of the low-priority queue and the high-priority queue for transmission to the master device, wherein respective reports indicate that the high-priority queue is empty when the high-priority queue has been empty for a length of time that satisfies a threshold and indicate that the high-priority queue has a non-zero queue size when the high-priority queue has been empty for a length of time that does not satisfy the threshold.

21. The slave device of claim 20, wherein:
the threshold is a threshold number of time periods; and
the slave device further comprises a counter to count a number of successive time periods in which the high-priority queue is empty.

22. A non-transitory computer-readable storage medium storing one or more programs configured to be executed by a device in a system comprising a master device coupled to a plurality of slave devices, the one or more programs comprising:
instructions to monitor the status of a low-priority queue and a high-priority queue in a slave device of the plurality of slave devices, wherein the low-priority queue stores low-priority upstream traffic and the high-priority queue stores high-priority upstream traffic;
instructions to measure a length of time for which the high-priority queue is empty;
instructions to determine whether the length of time satisfies a threshold;
instructions to reserve bandwidth for the high-priority queue when the high-priority queue is empty and the length of time does not satisfy the threshold; and
instructions to reserve no bandwidth for the high-priority queue when the high-priority queue is empty and the length of time satisfies the threshold.

23. A system comprising a master device coupled to a plurality of slave devices, wherein:
a respective slave device of the plurality of slave devices comprises:
a low-priority queue to store low-priority upstream traffic,
a high-priority queue to store high-priority upstream traffic, and
a report module to generate reports on the status of the low-priority queue and the high-priority queue for transmission to the master device; and
the master device comprises a scheduler to allocate bandwidth among the plurality of slave devices based at least in part on the reports;
wherein bandwidth is to be allocated for the high-priority queue when the high-priority queue is empty for a length of time that does not satisfy a threshold and no bandwidth is to be allocated for the high-priority queue when the high-priority queue is empty for a length of time that satisfies the threshold.
